(19) United States
(12) Patent Application Publication
(10) Pub. No.: US 2008/0253061 A1
(43) Pub. Date: Oct. 16, 2008

(54) VEHICLE OR MARINA POWER PEDESTAL INCLUDING TRANSIENT VOLTAGE SURGE SUPPRESSION

(76) Inventors: Paul D. Seff, Williamsburg, VA (US); Alston G. Brooks, Yorktown, VA (US); Gregory S. Nailler, Canonsburg, PA (US)

Correspondence Address: Martin J. Moran;Eaton Electrical, Inc., Technology & Quality Center, 170 Industry Drive, RIDC Park West, Pittsburgh, PA, 15275-1032, US

(21) Appl. No.: 11/733,817

(22) Filed: Apr. 11, 2007

(51) Int. Cl. H02B 1/26

(52) U.S. Cl. 361/622

(57) ABSTRACT

A vehicle power pedestal includes a pedestal member having a base structured to be fixed to a platform, and an enclosure extending from the base. A plurality of input power terminals are mounted to the pedestal member and structured to be electrically connected to a power source. A number of output power receptacles are mounted to the enclosure. Each of a number of circuit interrupters includes a line terminal electrically connected to one of the input power terminals and a load terminal electrically connected to one of the number of output power receptacles. A surge suppression module is mounted within the enclosure and is structured to suppress a transient voltage associated with the input power terminals and the number of output power receptacles.

### BACKGROUND OF THE INVENTION

1. Field of the Invention

This invention pertains generally to power pedestals and, more particularly, to vehicle or marina power pedestals.

2. Background Information

Various devices and arrangements are known for protecting loads from surges in supply voltage. Generally, two approaches are used: series and parallel protection. In series protection, a high impedance is used in series with the load during a surge to block or limit surge current. In parallel protection, the surge current is diverted with a low impedance shunt.

It is known to use voltage clamping devices and crowbar devices to provide parallel surge protection. The voltage clamping devices clamp the voltage across the load to a specified level. Common types of clamping devices include metal oxide varistors (MOVs), zener diodes and silicon avalanche diodes. If used alone to provide parallel protection, an MOV, for example, must have a clamping voltage that is above the nominal supply voltage in order that its maximum continuous operating voltage (MCOV) is above the nominal supply voltage. Known crowbar devices include gas discharge tubes and thyristors. These devices normally have a high impedance and switch to a low impedance when a surge in the supply voltage exceeds the breakdown voltage of the gas in the case of the gas discharge tube, or is high enough to activate a trigger circuit to turn the thyristor on.

Many manufacturers market surge protection devices for residential users. Various known devices and arrangements protect loads from surges in power supply voltage. Generally, both series and parallel protection are employed. Typically, if surge protection is desired, then customers (e.g., individuals; owners of buildings having multiple tenants, such as offices or apartments) purchase separate surge protection devices and wire those surge protection devices into the electrical power distribution system themselves. Alternatively, individuals may employ surge protection devices (e.g., outlet plug-ins; strips) at selected power outlets.

U.S. Pat. No. 6,844,716 discloses a utility distribution pedestal for marine and recreational vehicles. U.S. Pat. No. 6,844,716 also discloses a control circuit power supply of a metering system that is protected by surge protectors configured line-to-ground, line-to-neutral, and neutral-to-ground.

U.S. Patent Application Publication No. 2004/0233605 discloses a surge suppressor module for protecting electrical equipment connected to a residential alternating current (AC) power line, a telephone line, a cable television line or a satellite receiver.

Known power pedestals do not include a surge suppressor as an integral part of the power pedestal construction. As a result, users of such power pedestals must supply their own external surge suppressors or, otherwise, must assume the risk of damage caused by power line surges.

U.S. Pat. No. 6,087,818 discloses a recreational vehicle (RV) voltage booster device that boosts the actual voltage of 120 VAC power at an RV park power pedestal during brownout periods or other conditions of low voltage. A case-hardened U-bolt on the voltage booster device housing serves as a security chain loop that enables the owner to lock the unit to a power pedestal or other structure with a security chain. Metal oxide varistors are preferably included in the voltage booster device for surge protection.

There is room for improvement in vehicle or marina power pedestals.

### SUMMARY OF THE INVENTION

These needs and others are met by embodiments of the invention, which provide a power pedestal including an enclosure and a surge suppression circuit mounted within the enclosure. The surge suppression circuit is structured to suppress a transient voltage associated with input power terminals and a number of output power receptacles of the power pedestal.

In accordance with one aspect of the invention, a vehicle power pedestal comprises: a pedestal member comprising: a base structured to be fixed to a platform, and an enclosure extending from the base; a plurality of input power terminals mounted to the pedestal member and structured to be electrically connected to a power source; a number of output power receptacles mounted to the enclosure; a number of circuit interrupters, each of the number of circuit interrupters comprising a line terminal electrically connected to one of the input power terminals and a load terminal electrically connected to one of the number of output power receptacles; and a surge suppression circuit mounted within the enclosure and being structured to suppress a transient voltage associated with the input power terminals and the number of output power receptacles.

As another aspect of the invention, a vehicle power pedestal comprises: a pedestal member comprising: a base structured to be fixed to a platform, and an enclosure extending from the base, the enclosure including a number of openings; a plurality of input power terminals mounted to the pedestal member and structured to be electrically connected to a power source; a number of output power receptacles mounted to the enclosure; a number of circuit interrupters, each of the number of circuit interrupters comprising a line terminal electrically connected to one of the input power terminals and a load terminal electrically connected to one of the number of output power receptacles; and a surge suppression circuit mounted within the enclosure and being structured to suppress a transient voltage associated with the input power terminals and the number of output power receptacles, the surge suppression circuit comprising a number of indicators visible through the number of openings of the enclosure, each of the number of indicators being structured to indicate when a corresponding one of the input power terminals is energized.

As another aspect of the invention, a marina power pedestal comprises: a pedestal member comprising: a base structured to be fixed to a dock pier, and an enclosure extending from the base; a plurality of input power terminals mounted to the pedestal member and structured to be electrically connected to a power source; a number of output power receptacles mounted to the enclosure; a number of circuit interrupters, each of the number of circuit interrupters comprising a line terminal electrically connected to one of the input power terminals and a load terminal electrically connected to one of the number of output power receptacles; a surge suppression module mounted within the enclosure and being structured to suppress a transient voltage associated with the input power terminals and the number of output power receptacles; and a load electrically powered by at least some of the input power terminals.

### BRIEF DESCRIPTION OF THE DRAWINGS

A full understanding of the invention can be gained from the following description of the preferred embodiments when read in conjunction with the accompanying drawings in which:

FIG. 1 is an isometric view of a marina power pedestal in accordance with embodiments of the invention.

FIG. 2 is an isometric view of a marina power pedestal in accordance with another embodiment of the invention.

FIG. 3 is an isometric view of the input power terminals of the marina power pedestal of FIG. 2.

FIG. 4 is a block diagram in schematic form of the transient voltage surge suppression module and circuit breakers of FIG. 2.

FIG. 5 is a cross-sectional view of a portion of the enclosure of FIG. 2 showing the internal transient voltage surge suppression module.

FIGS. 6 and 7 are block diagrams in schematic form of circuit breakers, output power receptacles and an internal load of a marina power pedestal in accordance with other embodiments of the invention.

### DESCRIPTION OF THE PREFERRED EMBODIMENTS

As employed herein, the term “vehicle” shall expressly include, but not be limited by, a land vehicle, a marine vehicle, an air vehicle or another motor vehicle.

As employed herein, the term “land vehicle” shall expressly include, but not be limited by, any land-based vehicles having pneumatic tires, any rail-based vehicles, any maglev vehicles, automobiles, cars, trucks, station wagons, sport-utility vehicles (SUVs), recreational vehicles, construction vehicles, off road vehicles, all-terrain vehicles, farm vehicles, fleet vehicles, motor homes, vans, buses, motorcycles, mopeds, campers, trailers, or bicycles.

As employed herein, the term “marine vehicle” shall expressly include, but not be limited by, any water-based vehicles, ships, boats, other vessels for travel on water, submarines, or other vessels for travel under water.

As employed herein, the term “air vehicle” shall expressly include, but not be limited by, any air-based vehicles, airplanes, jets, aircraft, airships, balloons, blimps, or dirigibles.

As employed herein, the term “number” shall mean one or an integer greater than one (i.e., a plurality).

As employed herein, the term “platform” shall mean a horizontal flat surface, a raised horizontal flat surface, or a dock pier.

As employed herein, the term “pedestal” or “pedestal member” shall mean an elongated, generally upright structure.

As employed herein, the term “power pedestal” shall mean a pedestal or pedestal member structured to input power from input power terminals (e.g., utility power terminals) and output power to a number of output power receptacles.

As employed herein, the term “fastener” refers to any suitable connecting or tightening mechanism expressly including, but not limited to, screws, bolts and the combinations of bolts and nuts (e.g., without limitation, lock nuts) and bolts, washers and nuts.

As employed herein, the statement that two or more parts are “connected” or “coupled” together shall mean that the parts are joined together either directly or joined through one or more intermediate parts. Further, as employed herein, the statement that two or more parts are “attached” shall mean that the parts are joined together directly.

The invention is described in association with a marina power pedestal, although the invention is applicable to a wide range of vehicle power pedestals.

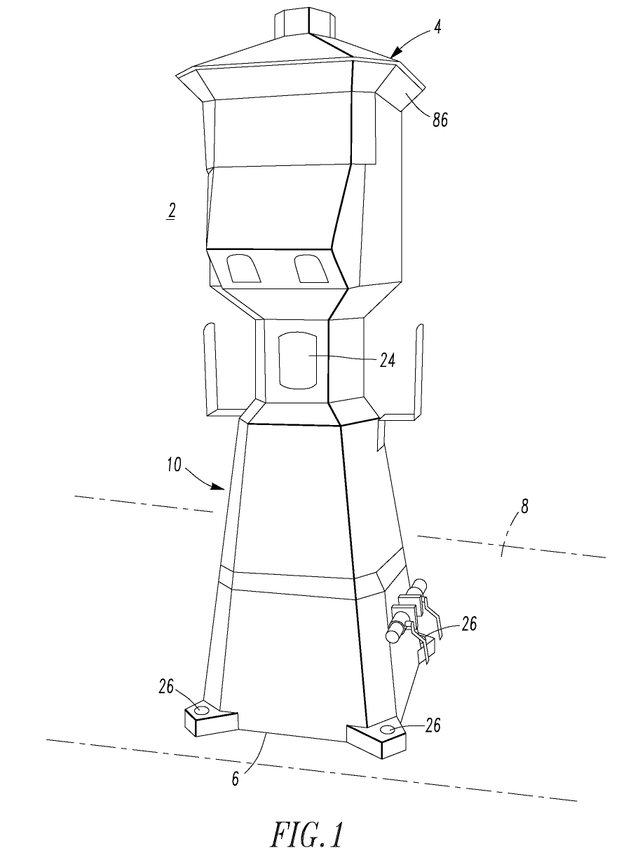

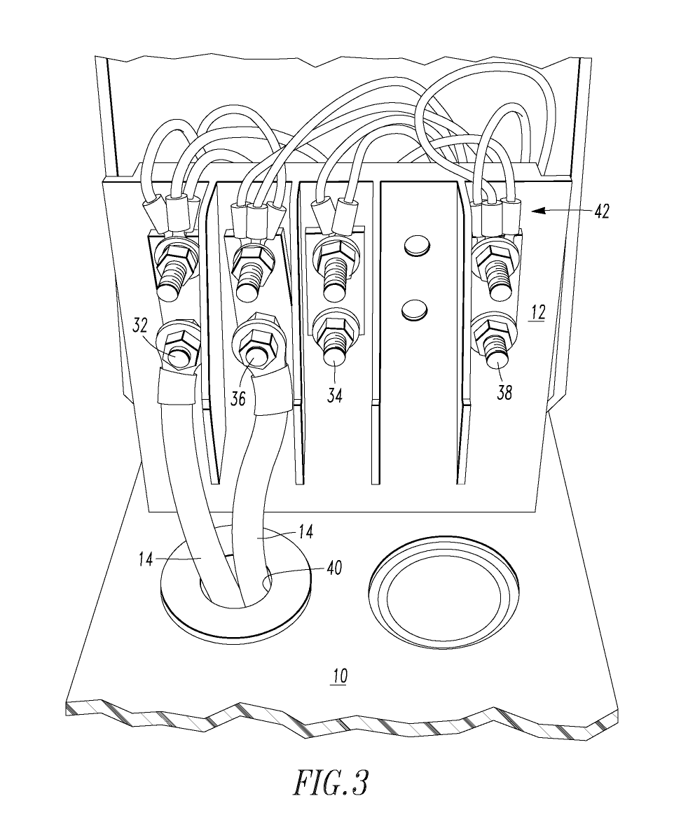

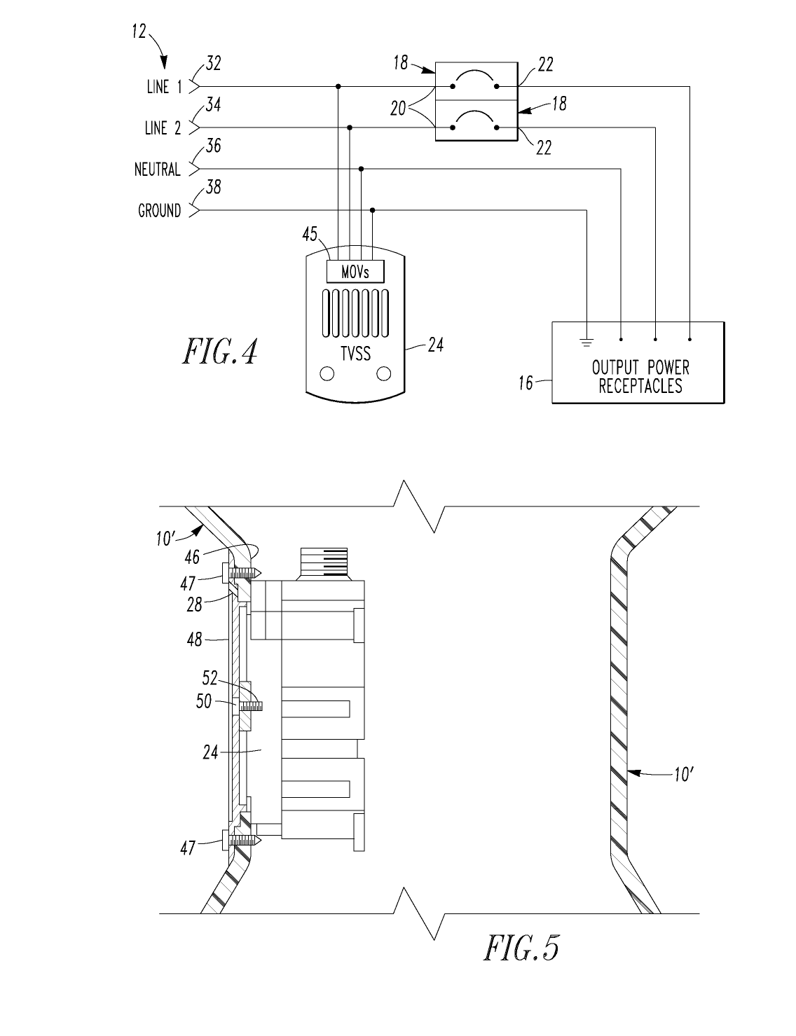

Referring to FIG. 1, a power pedestal, such as, for example and without limitation, a marina power pedestal 2 includes a pedestal member 4 having a base 6 structured to be fixed to a platform, such as, for example and without limitation, a dock pier 8 (shown in phantom line drawing) and an enclosure 10 extending generally vertically from the base 6. A plurality of input power terminals 12 (shown in FIG. 3) are mounted to the pedestal member 4 and are structured to be electrically connected to a power source (e.g., a utility power source) (not shown) by plural electrical conductors 14 (shown in FIG. 3). The marina power pedestal 2 also includes a number of output power receptacles 16 (shown in FIG. 4) mounted to the enclosure 10. The marina power pedestal 2 further includes a number of circuit interrupters, such as, for example and without limitation, circuit breakers 18 (two circuit breakers are shown in FIG. 4, although any suitable number may be employed). As shown in FIG. 4, each of the circuit breakers 18 includes a line terminal 20 electrically connected to one of the input power terminals 12 and a load terminal 22 electrically connected to one of the number of output power receptacles 16.

Although example circuit breakers 18 are shown, any suitable circuit interrupter (e.g., without limitation, a circuit breaker electrically connected in series with a contactor; a contactor electrically connected in series with a circuit breaker) may be employed.

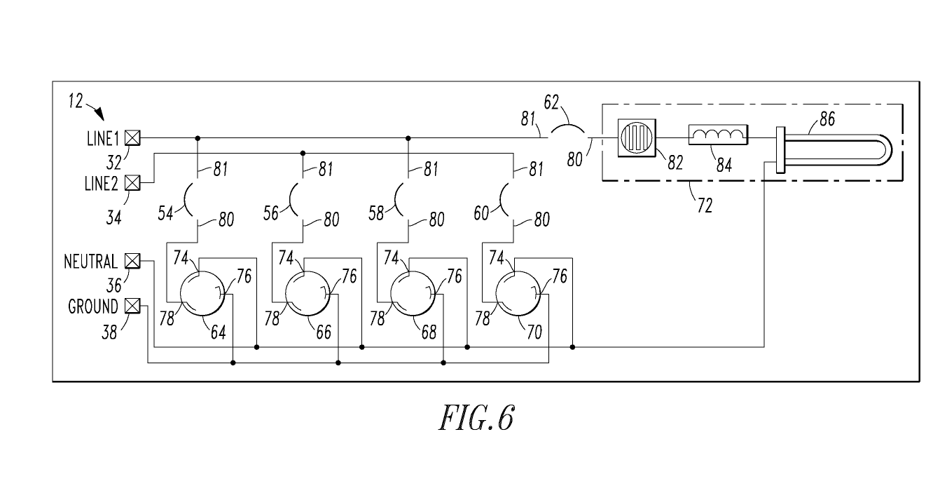

As will be discussed below in connection with FIGS. 4 and 5, a suitable surge suppression circuit, such as, for example and without limitation, a surge suppression module 24, is mounted within the enclosure 10 and is structured to suppress a transient voltage associated with the input power terminals 12 and the output power receptacles 16. An example of the surge suppression module 24 is disclosed in U.S. Patent Application Publication No. 2004/0233605, which is incorporated by reference herein. Another example of the surge suppression module 24 is a CHSP ULTRA™ module marked by Eaton Electrical, Inc. of Moon Township, Pa.

Although a dock pier 8 is disclosed, the platform may be any suitable platform, such as a concrete platform member at a recreational vehicle (RV) park. Thus, the power pedestal 2 may be a vehicle (e.g., without limitation, RV) power pedestal. The power pedestal base 6 includes a plurality of openings 26 structured to receive a plurality of fasteners (not shown) to fix the base 6 to the example dock pier 8 or other suitable platform.

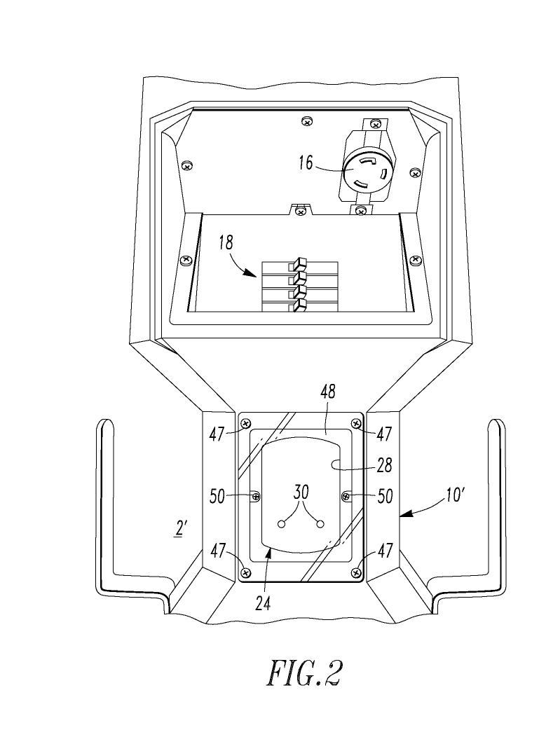

FIG. 2 shows another marina power pedestal 2′, which is substantially the same as the power pedestal 2 of FIG. 1, except that a door (not shown) has been opened or removed to show the circuit breakers 18 and output power receptacles 16. Also, in this example, the enclosure 10′ includes a number of openings 28 (one example opening is shown) and the surge suppression module 24 includes a number of indicators 30 (two example indicators are shown) visible through the corresponding number of enclosure openings 28. Each of the indicators 30 is structured to indicate when a corresponding one of the input power terminals 12 (FIG. 4) is energized. For example, one of the indicators 30 corresponds to one of the input power terminals 12 (e.g., without limitation, LINE1 32 of FIG. 3) and another one of the indicators 30 corresponds to another one of the input power terminals 12 (e.g., without limitation, LINE2 34 of FIG. 3).

Referring to FIG. 3, the input power terminals 12 of the marina power pedestal 2′ of FIG. 2 are shown. These terminals 12 include a first line terminal 32 (LINE1), a second line terminal 34 (LINE2), a neutral terminal 36 and a ground terminal 38. As shown by the two example electrical conductors 14, the terminals 32,34,36,38 are structured to be electrically connected to a suitable power source (not shown) by those conductors, which extend through the opening 40. It will be appreciated that the other terminals 34,38 may also be electrically connected to the power source by other electrical conductors (not shown). The other electrical conductors 42 are electrically connected to the circuit breakers 18, the transient voltage surge suppression (TVSS) module 24 and the output power receptacles 16 as shown in FIG. 4.

FIG. 4 shows the TVSS module 24 and some of the circuit breakers 18 of FIG. 2. The TVSS module 24 includes a plurality of metal oxide varistors (MOVs) 45 that are electrically connected between the first line terminal 32 and the ground terminal 38, the second line terminal 34 and the ground terminal 38, the first line terminal 32 and the neutral terminal 36, the second line terminal 34 and the neutral terminal 36, and the neutral terminal 36 and the ground terminal 38.

Input power (e.g., without limitation, from a suitable power line or electrical substation; LINE1 32 and LINE2 34) to the marina power pedestal 2′ is electrically connected to the input power terminals 12 inside of the power pedestal. The input power terminals 12, in turn, are electrically connected to the line terminals 20 of a suitable two-pole circuit interrupter, such as the two example circuit breakers 18, which are preferably ganged to operate together as is well-known. The line terminals 20 of the circuit breakers 18 and any and all output power receptacles 16 (e.g., power outlets) of the marina power pedestal 2′ are protected against transient voltages by the TVSS module 24 and are shunted through the MOVs 45 inside the TVSS module, thereby effectively reducing harmful transient voltages before being output to any electrical device (not shown) that is plugged into the output power receptacles 16.

Referring to FIG. 5, a portion of the enclosure 10′ of FIG. 2 encloses the TVSS module 24 therein. The TVSS module 24 is coupled to the internal surface 46 of the enclosure 10′ by four fasteners 47 (as best shown in FIG. 2). A transparent face plate 48 is coupled to the enclosure 10′ and to the TVSS module 24 by two fasteners 50 (as best shown in FIG. 2) that engage the module 24 at openings 52 (only one opening is shown in FIG. 5). The TVSS module 24 and the indicators 30 thereof are visible though the opening 28 and the transparent face plate 48. Alternatively, two relatively small openings (not shown) for the two indicators 30 may be employed and, thus, the relatively larger opening 28 and face plate 48 need not be employed.

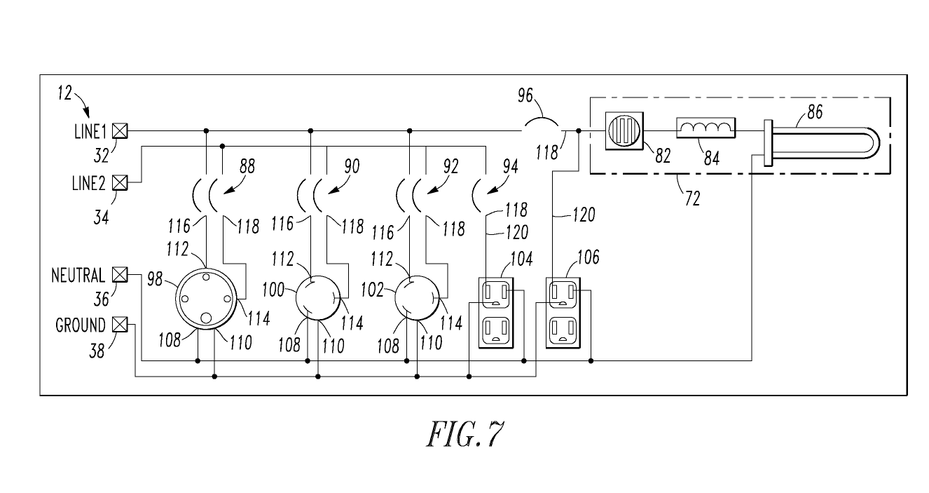

FIG. 6 shows circuit breakers 54,56,58,60,62, output power receptacles 64,66,68,70 and an internal load 72 of a marina power pedestal, such as the pedestals 2,2′ of FIGS. 1 and 2. Each of the output power receptacles 64,66,68,70 includes a neutral terminal 74 electrically connected to the neutral terminal 36 of the input power terminals 12, a ground terminal 76 electrically connected to the ground terminal 38 of the input power terminals 12, and a line terminal 78 electrically connected to the load terminal 80 of a corresponding one of the circuit breakers 54,56,58,60. The line terminals 81 of the circuit breakers 54,58,62 are electrically connected to the first line terminal 32, and the line terminals 81 of the circuit breakers 56,60 are electrically connected to the second line terminal 34. The example internal load 72 includes a photocell 82, a ballast 84 and a lamp 86 that are electrically connected in series between the load terminal 80 of the circuit breaker 62 and the neutral terminal 36. The lamp 86 may be disposed near the top (with respect to FIG. 1) of the power pedestal 2. The load 72, alternatively, may be powered from the other line terminal 34 or from both of the line terminals 32,34. The TVSS module 24 (not shown in FIG. 6) is electrically connected to the input power terminals 12 as shown in FIG. 4.

FIG. 7 shows example two-pole circuit breakers 88,90,92, single-pole circuit breakers 94,96, output power receptacles 98,100,102,104,106 (e.g., without limitation 240 VAC; 120 VAC) and the internal load 72 of a marina power pedestal, such as the pedestals 2,2′ of FIGS. 1 and 2. Each of the output power receptacles 98,100,102 includes a neutral terminal 108 electrically connected to the neutral terminal 36 of the input power terminals 12, a ground terminal 110 electrically connected to the ground terminal 38 of the input power terminals 12, and two line terminals 112,114 electrically connected to the respective load terminals 116,118 of a corresponding one of the two-pole circuit breakers 88,90,92. The TVSS module 24 (not shown in FIG. 7) is electrically connected to the input power terminals 12 as shown in FIG. 4. The example receptacles 104,106 are ground fault circuit interrupter (GFCI) receptacles. The load terminal 118 of the circuit breaker 94 is electrically connected to the line terminal 120 of the GFCI receptacle 104, and the load terminal 118 of the circuit breaker 96 is electrically connected to the line terminal 120 of the GFCI receptacle 106.

The disclosed marina power pedestals 2,2′ and the internal TVSS module 24 provide surge protection for vehicles (not shown) or other electrical devices (not shown) that plug into the output power receptacles 16 of those pedestals.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

1. (canceled)

2. The vehicle power pedestal of claim 13 wherein said platform is a pier.

3. The vehicle power pedestal of claim 13 wherein said platform is a platform member at a recreational vehicle park.

4. The vehicle power pedestal of claim 13 wherein said enclosure is a housing extending generally vertically from said base.

5. The vehicle power pedestal of claim 13 wherein said number of circuit interrupters is a plurality of circuit breakers.

6. The vehicle power pedestal of claim 13 wherein said input power terminals comprise a first line terminal, a second line terminal, a neutral terminal and a ground terminal; wherein at least one of said first and second line terminals is electrically connected to the line terminal of a corresponding one of said number of circuit interrupters; and wherein said surge suppression circuit comprises a plurality of metal oxide varistors structured to be electrically connected between said first line terminal and said ground terminal, said second line terminal and said ground terminal, said first line terminal and said neutral terminal, said second line terminal and said neutral terminal, and said neutral terminal and said ground terminal.

7. The vehicle power pedestal of claim 6 wherein each of said number of output power receptacles comprises a neutral terminal electrically connected to the neutral terminal of said input power terminals, a ground terminal electrically connected to the ground terminal of said input power terminals, and a line terminal electrically connected to the load terminal of a corresponding one of said number of circuit interrupters.

8. The vehicle power pedestal of claim 6 wherein said number of circuit interrupters is a number of two-pole circuit breakers including a first pole and a second pole; wherein one of said first and second line terminals is electrically connected to the first pole of one of said number of two-pole circuit breakers; and wherein another one of said first and second line terminals is electrically connected to the second pole of one of said number of two-pole circuit breakers.

9. The vehicle power pedestal of claim 6 wherein said number of output power receptacles includes a number of ground fault circuit interrupter receptacles.

10. The vehicle power pedestal of claim 6 wherein said number of circuit interrupters is a plurality of circuit breakers; wherein one of said first and second line terminals is electrically connected to the line terminal of a first one of said circuit breakers; and wherein another one of said first and second line terminals is electrically connected to the line terminal of a second one of said circuit breakers.

11. The vehicle power pedestal of claim 6 wherein said number of circuit interrupters is a number of circuit breakers; wherein said number of output power receptacles includes a number of ground fault circuit interrupter receptacles; wherein one of said first and second line terminals is electrically connected to the line terminal of a corresponding one of said circuit breakers; and wherein another one of said first and second line terminals is electrically connected to a corresponding one of said ground fault circuit interrupter receptacles.

12. The vehicle power pedestal of claim 13 wherein said base includes a plurality of openings structured to receive a plurality of fasteners to fix said base to said platform.

13. A vehicle power pedestal comprising:
a pedestal member comprising:
a base structured to be fixed to a platform, and
an enclosure extending from said base, said enclosure including a number of openings;
a plurality of input power terminals mounted to said pedestal member and structured to be electrically connected to a power source;
a number of output power receptacles mounted to said enclosure;
a number of circuit interrupters, each of said number of circuit interrupters comprising a line terminal electrically connected to one of said input power terminals and a load terminal electrically connected to one of said number of output power receptacles; and
a surge suppression circuit mounted within said enclosure and being structured to suppress a transient voltage associated with said input power terminals and said number of output power receptacles, said surge suppression circuit comprising a number of indicators visible through said number of openings of said enclosure, each of said number of indicators being structured to indicate when a corresponding one of said input power terminals is energized.

14. The vehicle power pedestal of claim 13 wherein said platform is a platform member at a recreational vehicle park.

15. The vehicle power pedestal of claim 13 wherein said number of circuit interrupters is a plurality of circuit breakers; wherein one of said first and second line terminals is electrically connected to the line terminal of a first one of said circuit breakers; and wherein another one of said first and second line terminals is electrically connected to the line terminal of a second one of said circuit breakers.

16. A marina power pedestal comprising:
a pedestal member comprising:
a base structured to be fixed to a dock pier, and
an enclosure extending from said base, said enclosure including a number of openings;
a plurality of input power terminals mounted to said pedestal member and structured to be electrically connected to a power source;
a number of output power receptacles mounted to said enclosure;
a number of circuit interrupters, each of said number of circuit interrupters comprising a line terminal electrically connected to one of said input power terminals and a load terminal electrically connected to one of said number of output power receptacles;
a surge suppression module mounted within said enclosure and being structured to suppress a transient voltage associated with said input power terminals and said number of output power receptacles, said surge suppression module comprising a plurality of indicators visible through said number of openings of said enclosure, each of said plurality of indicators being structured to indicate when a corresponding one of said input power terminals is energized; and
a load electrically powered by at least some of said input power terminals.

17. The marina power pedestal of claim 16 wherein one of said input power terminals is a neutral terminal; and wherein said load comprises a photocell, a ballast and a lamp being electrically connected in series between said load terminal and said neutral terminal.

18. The marina power pedestal of claim 16 wherein said enclosure is a housing extending generally vertically from said base.

19. The marina power pedestal of claim 16 wherein said number of circuit interrupters is a plurality of circuit breakers.

20. The marina power pedestal of claim 16 wherein said number of output power receptacles includes a number of ground fault circuit interrupter receptacles.
